(19) United States
(12) Patent Application Publication
(10) Pub. No.: US 2014/0358801 A1
(43) Pub. Date: Dec. 4, 2014

(54) RENTAL PROPERTY EVALUATION SYSTEM AND METHOD

(71) Applicants: Jeff Pierce, Sherman, TX (US); Cheri Garcia, Dallas, TX (US)

(72) Inventors: Jeff Pierce, Sherman, TX (US); Cheri Garcia, Dallas, TX (US)

(21) Appl. No.: 14/265,354

(22) Filed: Apr. 29, 2014

Related U.S. Application Data
(60) Provisional application No. 61/854,592, filed on Apr. 29, 2013.

(51) Int. Cl. G06Q 30/06; G06F 3/0484; G06Q 50/16

(52) U.S. Cl. CPC G06Q 30/0645; G06Q 50/163; G06F 3/04842
USPC 705/307

(57) ABSTRACT

The present invention provides systems, methods and devices that accurately and objectively manage tracking the quality of rental property, and in particular the quality of rented units.

### CLAIM OF PRIORITY

This utility patent application is related to and claims priority from US Provisional Patent Application No. 61/854,592 entitled RENT EVALUATION NOTE TAKER filed on Apr. 29, 2013 to common inventor Jeffrey Pierce of Sherman, Tex.

### FIELD OF THE INVENTION

The present invention relates generally to rental property and lease property management.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

Anyone who has ever rented an apartment from a landlord, and every landlord, is familiar with the posting of a security deposit (which may have a different name from state-to-state or contract-to-contract). Typically, the deposit is a required term for entering into the lease. Then at the end of the lease, the property is evaluated for damage and deductions are made against the security deposit. Inevitably, there are disputes between management and the tenant over the actual condition and functioning of the property and its appliances. Accordingly, there exists the need for systems, methods and devices that accurately and objectively manage evaluating property statuses before and after the lease; the invention disclosed herein provides such systems, methods and devices.

### BRIEF DESCRIPTION OF THE DRAWINGS

Various aspects of the invention, as well as an embodiment, are better understood by reference to the following detailed description. The detailed description, given by way of examples and not intended to limit the present invention solely thereto, will be better understood when read in conjunction with the drawings wherein like reference numerals denote like elements and parts in which:

FIG. 1 illustrates a property selection algorithm 100.

FIG. 2 illustrates a property evaluation algorithm 200.

FIG. 3 illustrates a property file management algorithm 300.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise. As will be understood by those of ordinary skill in the art, various structures and devices are depicted in block diagram form in order to avoid unnecessarily obscuring the invention.

It should be noted in the following discussion that acts with like names are performed in like manners, unless otherwise stated. Of course, the foregoing discussions and definitions are provided for clarification purposes and are not limiting. Words and phrases are to be given their ordinary plain meaning unless indicated otherwise.

### DETAILED DESCRIPTION OF THE DRAWINGS

### Overview

The invention allows users to create inspection evaluations for multiple properties or units (such a apartments and rental homes), attach photos, and send a PDF or other file of the completed evaluation via email. The user, typically a property manager, preferably selects a property from a list of properties (which may identify and allow access to multiple units within a particular property), or if the property is not present in the system, a manager may create a separate property or property record for each unit. After creating a new property, the user selects the property to create a new evaluation form. After creating the new evaluation form, the user selects a form to begin an evaluation (or, “walk-through”).

The properties are preferably displayed as a Property List. A Property Overview may be viewed for each unit, which preferably displays information such as the property address, the tenant(s) and associated contact information, and any documents associated with the property identified in the Property Overview.

The user uses the apparatus, which is preferably a handheld device such as a smart phone or tablet, or portable computer to take any needed pictures and then stores these pictures along with walk-through evaluation information.

In one embodiment, the property manager may enable an apartment renter to conduct their own initial inspection upon moving into a unit. Then, when they move out of a unit, they can conduct an exit inspection and compare the move-in and move-out pictures and evaluation. In this embodiment, the renter is restricted to viewing only his or her own property unit, and may have limited access to the attached files (such as photos of the property that are outside the term of their lease, maintenance records, or complaint records, for example).

### Description of the Figures

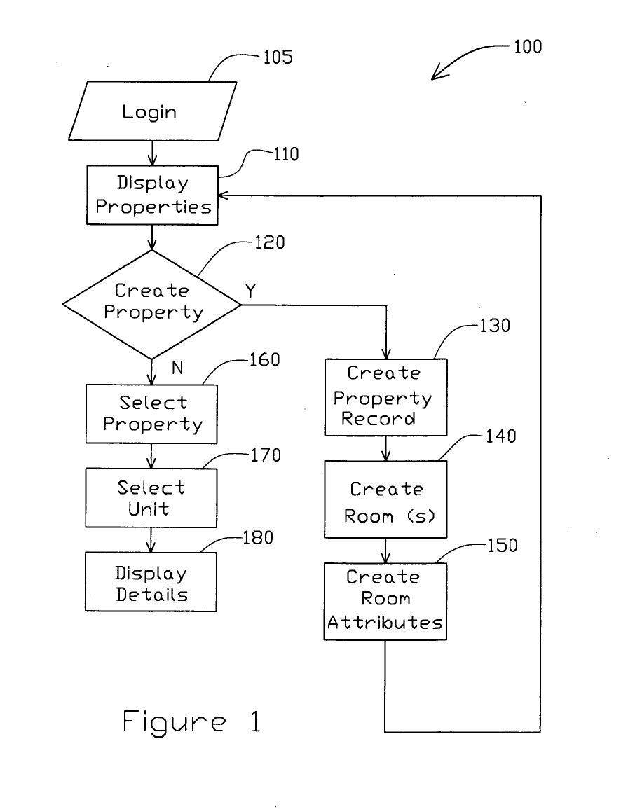

FIG. 1 illustrates a property selection algorithm 100, which is a computer-implemented method. The algorithm 100 begins with a user login act 105 in which a user accesses the underlying program that executes the algorithm 100 via a computer processor. Then, in a display properties act 110, a list of properties under management is displayed on a graphical user interface; the list of properties typically comprises a plurality of property record indicators (typically text such as a property name or address, but which may also comprise graphics, buttons, or icons, for example). Next, a user may indicate that a new property needs to be added to the computer program executing the algorithm 100 in a create property query 120. So, in the event that no properties are displayed, or that a particular property that is to be evaluated is not displayed, then the algorithm follows the “Y” path where a user can create a property record via a create property record act 130. The create property record act 130 preferably allows a user to name the added property, as well as enter specific data about the property, such as an address, tenant name, and lease information, for example.

In a create room act 140, the user creates room records for each room for which an evaluation is desired. For example, a user could create a room record for a bedroom, a bathroom, a kitchen, a breakfast nook, a living room, and a laundry room for a unit in an apartment complex. Then in a create room attributes act 150, the user defines the surfaces and items (or other structures, including smells) in the room which are to be evaluated, such as walls, carpet/flooring, countertops, stove, range, hot water heater, washer, or dryer, for example. Of course, in an alternative embodiment a first room can be associated with items or surfaces before identifying a second room, and so on. After the additional room record is created, an additional property record identifier is displayed along with the previously available property record identifiers.

Next, in a select property act 160, the algorithm 100 receives a user-selection of the property record identifier, and provides the property record to the user. In the event the property selected in the select property act 160 has more than one unit, in a select unit act 170 the algorithm 100 receives a user-selection of a unit identifier. Then, in a display details act 180 the algorithm provides data associated with the selected property or property/unit combination (unless otherwise stated, a property includes any of its units), which may comprise any attribute information or property details, above, and may include a display of files on record that are associated with that property.

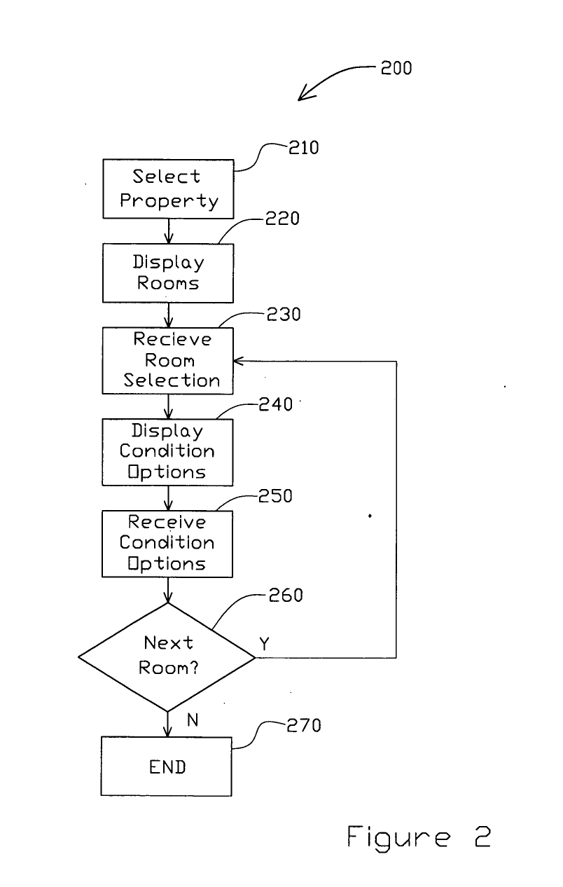

FIG. 2 illustrates a property evaluation algorithm 200, which is a computer-implemented method. First in a select property act 210, a property for evaluation is selected. A preferred method of property selection is the method of the algorithm 100. Next, in a display rooms act 220, the algorithm 200 displays a list of rooms that are to be evaluated, and a user then selects a room to evaluate in a select rooms act 230. Following the selection of the room to evaluate, in a display conditions and options act 240, surfaces and items to be evaluated are displayed. A user preferably then assigns a grade or scale or other indication of surface or item quality/condition which is received by the algorithm 200 in a receive condition indicator(s) act 250, in which the user may also record notes or associate pictures or video. Next, in a next room query 260, the algorithm 200 determines whether or not another room needs to be evaluated. If so, as shown via the “Y” decision path, the algorithm 200 returns to the receive room selection act 230 to repeat the relevant acts of the algorithm 200. If there is not another room to evaluate, the algorithm 200 proceeds along via the “N” decision path to the end act 270 in which the evaluation is stored, along with associated files, and the algorithm 200 ends.

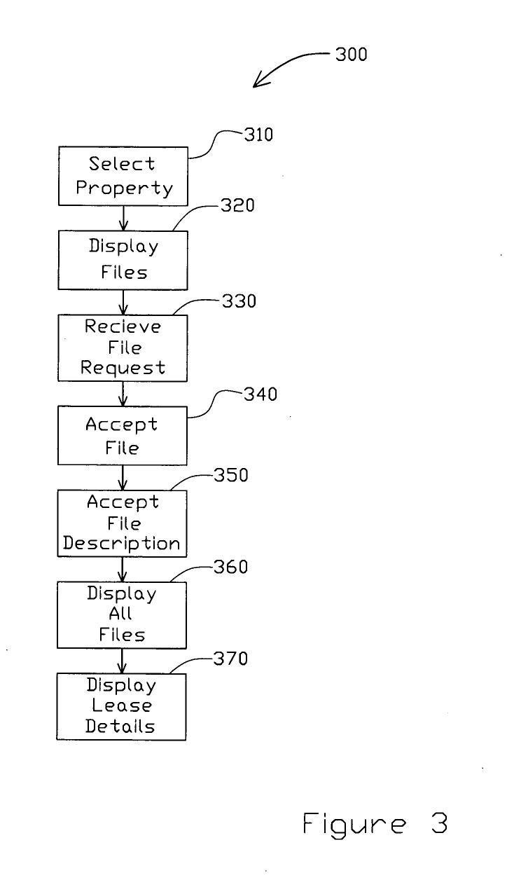

FIG. 3 illustrates a property file management algorithm 300, which is a computer-implemented method. The algorithm 300 begins with a select property act 310 which is preferably the algorithm 100, and then proceeds to a display files act 320 in which all files associated with the selected property are displayed. Of note, if a tenant is conducting the evaluation, then certain files and records will not be displayed to the tenant, such as obsolete files, complaint letters, or records related to other tenants, for example. Next in a receive file request act 330 the algorithm 300 receives an indication that the user wishes to load or otherwise associate a file with the property record. Accordingly, in an accept file act 340, the file is associated with the property, and the user may then add information regarding the file to the property record and/or the file record (which may include metadata) which is received by the algorithm 300 in an accept file description act 350. Then, in a display all files act 360 the algorithm 300 displays all the files associated with the property and may simultaneously or via a second display present lease details to the user in a display lease details act 370.

Though the invention has been described with respect to specific preferred embodiments, many variations and modifications will become apparent to those skilled in the art upon reading the present application. Specifically, the invention may be altered in ways readily apparent to those of ordinary skill in the art upon reading the present disclosure. It is therefore the intention that the appended claims and their equivalents be interpreted as broadly as possible in view of the prior art to include all such variations and modifications.

I claim:

1. A computer-implemented method, comprising:
displaying at least a first property record identifier on a graphical user interface, the first property record identifier being associated with a first property record;
receiving a user-selection of the first property record identifier;
displaying the first property record, the first property record comprising attributes or associated files;
displaying at least a first room identifier on the graphical user interface;
receiving a user-selection of the first room identifier, the first room identifier being associated with at least a first surface or item;
receiving a user selection of a quality associated with the first surface or item.

2. The method of claim 1 further comprising:
receiving a user selection indicating that an additional property record is to be created;
receiving data to define the additional property record;
receiving data to define at least a first room of the additional property record; and
receiving data to define at least a first attribute associated with the first room.

3. The method of claim 1 wherein the property record identifier is a text name of the first property.

4. The method of claim 1 further comprising displaying a second property record identifier, and the first property record identifier in combination with the second property record identifier define a list of property records.

5. The method of claim 1 wherein the first property record comprises a plurality of units, and further comprising receiving a user-selection of a first unit identifier having a first unit property record associated therewith.

6. A computer-implemented method, comprising:
displaying at least a first property record identifier and a second property record identifier on a graphical user interface, the first property record identifier being associated with a first property record and the second property record identifier being associated with a second property record;
receiving a user selection indicating that an additional property record is to be created;
receiving data to define the additional property record;
receiving data to define at least a first room of the additional property record; and
receiving data to define at least a first attribute associated with the first room;
displaying the first property record identifier, the second property record identifier, and an additional property record identifier associated with the additional property record;
receiving a user-selection of the additional property record identifier;
displaying the additional property record, the additional property record comprising attributes;
displaying at least a first room identifier and a second room identifier on the graphical user interface;
receiving a user-selection of the first room identifier, the first room identifier being associated with at least a first surface or item;
receiving a user selection of a quality associated with the first surface or item.
